(19) United States
(12) Patent Application Publication
(10) Pub. No.: US 2026/0362159 A1
(43) Pub. Date: Nov. 12, 2026

(54) SYSTEMS AND METHODS TO FACILITATE MANAGEMENT OF NON-TERRESTRIAL NETWORKS (NTN) AND SUPPLEMENTAL COVERAGE FROM SPACE (SCS) FOR INTEGRATION WITH TERRESTRIAL NETWORKS (TN)

(71) Applicant: AALYRIA TECHNOLOGIES, INC., LIVERMORE, CA (US)

(72) Inventors: STEFAN DRASKOCI, LONDON (GB); BRIAN BARRITT, PITTSBURGH, PA (US); LUCA LODIGIANI, LONDON (GB)

(21) Appl. No.: 19/666,227

(22) Filed: May 2, 2026

Related U.S. Application Data
(60) Provisional application No. 63/801,286, filed on May 7, 2025.
(60) Provisional application No. 63/886,590, filed on Sep. 23, 2025.

(51) Int. Cl. H04W 16/26; H04W 16/28; H04W 84/06

(52) U.S. Cl. CPC H04W 16/26; H04W 16/28; H04W 84/06

(57) ABSTRACT

The current disclosure utilizes systems and methods for managing satellite-based wireless coverage by automatically controlling the creation, adjustment, and removal of satellite cells and beams. A network controller may coordinate terrestrial network resources and non-terrestrial network resources to dynamically map coverage areas.

### CROSS REFERENCE TO RELATED APPLICATIONS

This U.S. Non-Provisional Application claims the benefit of priority U.S. Provisional Application No. 63/886,590, filed Sep. 23, 2025; and also claims the benefit of priority U.S. Provisional Application No. 63/801,286, filed May 7, 2025, the disclosures of which are incorporated by reference herein in their entirety.

### BACKGROUND

Gaps in connectivity may exist where the deployment of terrestrial base stations has proven to be physically infeasible or commercially unavailable. Proprietary satellite systems may be utilized to serve such remote regions, however these have in most cases proven to be too inaccessible and impractical to the end user to see widespread adoption.

The 3GPP family of standards for mobile networks has achieved global adoption and usage and has given rise to billions of mobile devices which support a number of generations of the standard (3G, 4G, 5G, etc.). The combination of these standards with the ubiquitous reach of satellites presents a compelling solution to deliver connectivity to unconnected regions and people.

This opportunity was recognized in 3GPP and has been actively addressed in recent years as a new flavor of the 5G NR standard, called 5G Non-Terrestrial Networks (NTN). Non-Terrestrial Networks may utilize spaceborne (e.g., satellites), airborne (e.g., drones or balloons), or other non-ground-based platforms to act as a repeater of a 5G waveform which may be generated on the ground. In an example, Low Earth Orbit (LEO) satellite constellations may be the preferred mode of delivery (e.g., via earth-fixed cells or satellite-fixed cells). In this example, a 5G gNodeB Radio Access Network (RAN) stack may generate a downlink (DL) NR-Uu waveform that may be transmitted by a NTN gateway to the LEO satellite(s) via a feeder link, where the NR-Uu waveform may be repeated, typically on another frequency, and retransmitted down to a terrestrial mobile device, a user equipment (UE), on a service link. In contrast, an uplink NR-Uu waveform may follow a reverse path, being transmitted by the UE via the service link to the LEO satellite(s), where the signal is retransmitted via the feeder link down to the NTN gateway and 5G gNodeB RAN.

In some examples, RAN components may be proprietary or tightly integrated by a single vendor. In other examples, such as an Open Radio Access Network (O-RAN), the RAN may be split into modular components that may come from different vendors. The use of open interfaces may enable the equipment from different vendors to work together.

Subsequent releases of 3GPP may tackle the complexities of hosting a 5G gNodeB onboard satellites and having the capability to route traffic flows over Inter-Satellite Links (ISLs) to other satellites. These kinds of networks may offer greater flexibility to the end-to-end delivery of connectivity, but in doing so they may also increase operational complexity. Over time, Direct-to-Device 5G NTN services will evolve towards being capable of delivering higher data rates to the UE(s) to support different services.

The market is trending towards 5G NTN constellations being owned and operated by incumbent and emerging Satellite Network Operators (SNOs), who are distinct to the terrestrial Mobile Network Operators (MNOs) whose coverage gaps they are filling. Supplemental Coverage from Space (SCS) may provide an example in which SNO coverage may fill coverage gaps in the MNO coverage. Each independent 5G NTN constellation is intended to act as a logical extension of a number of 5G terrestrial networks all over the world, where the mobile devices are expected to roam onto the former in the absence of the latter. The end goal is to enable mobile users to consume connectivity services with minimal impact on their perceived experience, including seamless transitions/handovers between 5G Terrestrial Networks (TNs) and 5G NTNs. A key challenge in achieving this end goal is that the current 3GPP standards do not sufficiently address the architectural implementations and processes by which 5G TNs and NTNs will integrate and coordinate at the RAN and Core levels, to allow mobile devices (UEs) to be seamlessly handed over from one to the other.

Terrestrial network coverage gaps are in some cases quite wide, while in other cases significantly smaller. A UE driving on a highway might leave, re-enter, and again leave the terrestrial coverage area every couple of minutes. In order to assure seamless consumption of connectivity services, the network should be capable of maintaining voice and data-based conversations (e.g., WhatsApp) during the handovers between the TN and the NTN. In handover events between terrestrial base stations, this is achieved either by having an interface between the two gNodeBs which allows them to coordinate (e.g., the Xn interface), or by having them do so via their common Core Network (e.g., via the Next Generation (NG) interface). The establishment of this kind of interfacing on a global scale between the SNOs and various MNOs would be very difficult to achieve. As such, another key challenge is that current 3GPP standards for 5G NTN account for traditional mobile roaming between operators as being the handover procedure for transitions between the two, which would pose a significant interruption for a user to their consumption of connectivity services.

There are new NTN control plane signaling measures that were introduced by 3GPP to aid UEs for the initial access and mobility procedures, such as the System Information Block 19 (SIB19). These are intended to be unicast or broadcast by the TN RAN to UEs which are soon to be connected to the NTN network. The UEs use this information about their target satellite to properly synchronize in time and frequency with the NTN segment, to facilitate TN-to-NTN handover. In integrated TN and NTN environments, maintaining seamless coverages is challenged by dynamic conditions that may introduce or exacerbate coverage gaps within or between the two domains. Factors such as atmospheric interference, terrain obstructions, and satellite beam transitions can disrupt connectivity. These disruptions may necessitate mechanisms for proactive planning and real-time awareness to ensure continuity in network coverage. These mechanisms may include systems or methods to anticipate, detect, or respond to coverage gaps between TN and NTN, including SCS, to maintain reliable communication across diverse contexts.

### SUMMARY

The current disclosure may utilize NTN or SCS resources to automatically orchestrate or control an SNO's ground and space segment, including dynamic creation, modification, deletion, and mapping of satellite cells and beams to target areas.

In a first aspect a method is provided for managing coverage provided by terrestrial networks (TN) and non-terrestrial networks (NTN) in an integrated manner. The method includes steps of: (A) modeling telecommunication network coverage provided by terrestrial networks (TN) and non-terrestrial networks (NTN); and (B) mobilizing one or more platforms to provide telecommunication network coverage in the one or more white spots.

In an example aspect, modeling telecommunication network coverage provided by TN and NTN may include: (i) detecting a group of one or more platforms in an NTN, which may include at least one of one or more satellites, one or more high-altitude platform stations (HAPS), and one or more unmanned aerial vehicles (UAV), and manned aerial vehicles; (ii) determining a beam layout of telecommunication network coverage provided by the NTN, which may include one or more areas that beams from platforms in the group may cover based on slant range, orbit precession, beam shape, beam size, beam center, beam direction, and antenna patterns; (iii) determining telecommunication network coverage provided by one or more first network cells; and (iv) detecting one or more white spots, which may include one or more gaps in terrestrial cell coverage. In some examples, the NTN may include supplemental coverage from space (SCS). In these examples, the group of one or more platforms may include a constellation of one or more satellites.

In another example aspect, mobilizing, using a network orchestration system that coordinates terrestrial and non-terrestrial resources, the one or more platforms to provide telecommunication network coverage in the one or more white spots may include: (i) creating one or more second network cells, which may include one or more parameters, including an absolute radio-frequency channel number, bandwidth, and synchronization signal block, wherein the one or more second network cells comprise a geographic location identical to a geographic location of the one or more white spots; (ii) reading the one or more second network cell parameters; (iii) updating the one or more second network cell parameters; (iv) removing a second network cell logical object, which may include a cell identity, physical cell identity, frequency, bandwidth, neighboring cells, configuration, and performance metrics; (v) activating one or more platforms in the group; (vi) configuring the one or more platforms to configure the beams with coverage for the one or more second network cells; (vii) assigning a power and frequency to the one or more beams; and (viii) illuminating a network cell using the one or more beams. In some examples, the one or more second network cells may include one or more new radio cells. In other examples, the one or more second network cells may include one or more long-term evolution cells.

In yet another example aspect, the method may include determining the one or more white spots are collocated with one or more earth-fixed cells (EFC) and mobilizing the one or more earth-fixed cells to provide telecommunication network coverage to the one or more white spots. In some examples, the one or more EFCs may be components of an SCS network.

In yet another example aspect, the method may include determining that a platform is no longer eligible to illuminate a network and deactivating a beam from the ineligible platform. In yet another example, the method may include providing coverage, using one or more platforms, to one or more second network cells in a coverage area by time-multiplexing one or more beams across the one or more network cells.

### DESCRIPTION OF THE DRAWINGS

FIG. 1A is a diagram of an example telecommunications network in accordance with an example of the present disclosure.

FIG. 1B is a diagram of an example telecommunications network in accordance with an example of the present disclosure.

FIG. 2 is a diagram of an example platform providing network coverage to one or more network cells in accordance with an example of the present disclosure.

FIG. 3 illustrates an example flowchart illustrating operations for managing coverage provided by a terrestrial network and non-terrestrial network in accordance with an example of the present disclosure.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

Real-time, dynamic mapping of NTN, or SCS, coverage to target coverage areas may require a plurality of operations on the satellite layer, across the ground and space segment. Several factors may impact the accurate mapping or deployment of beams to Earth-Fixed Cells (EFCs). These factors may include satellite payload power or dynamic changes in slant range, which extend the footprint of the cells close to the edge of coverage, as well as inter-beam or inter-cell interference. Feeder link to satellite user link cell mapping may be influenced by various factors, including weather. Additionally, the relative position of satellites to the coverage area may change due to orbital precession, which may necessitate a re-mapping of the satellite cells to beams or satellites. As satellites enter, exit and/or alternate over a coverage area, inter-satellite switching or handover may be required to maintain coverage.

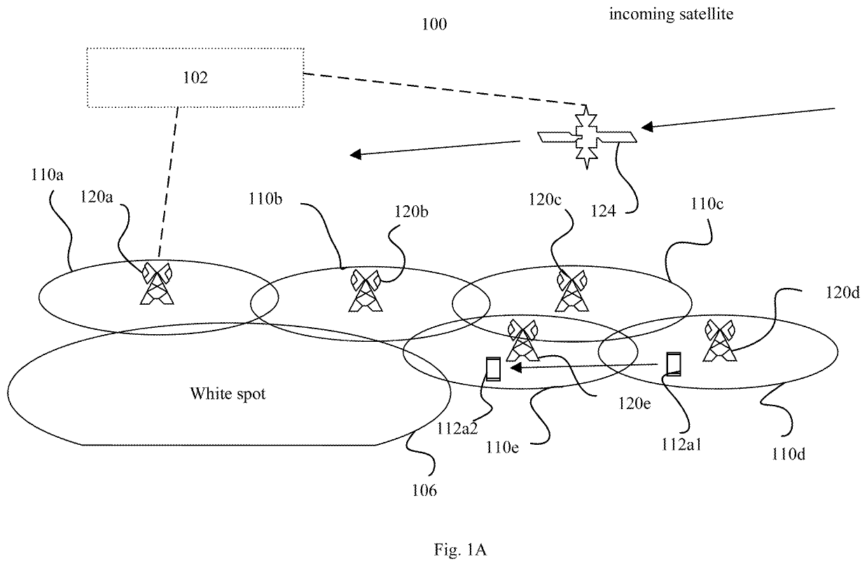

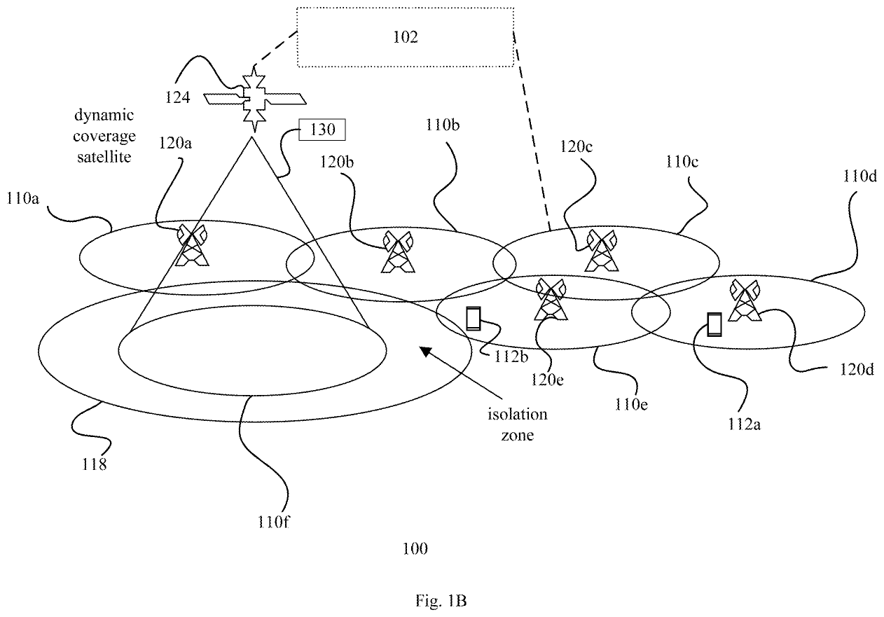

As illustrated in FIGS. 1A and 1B, telecommunications network 100 may include a TN and/or an NTN. Network 100 may be configured to deliver wireless connectivity using TN and/or NTN resources. By utilizing a hybrid network architecture, network 100 may enable broad and flexible coverage, including in areas where terrestrial infrastructure may be limited or unavailable. At FIGS. 1A and 1B, controller 102 may include a service management and orchestration (SMO) framework that may be capable of managing TN and NTN, including those that may be operated by SNOs. In some examples, controller 102 may be configured to perform one or more functions of a Non-RT RIC and/or Near-RT RIC. At FIGS. 1A and 1B, controller 102 may include a solver configured to optimize an NTN, process inputs from a network, and/or support RIC application (rApp) or extensible applications (xApp). In some examples, the solver may be part of an artificial intelligence (AI) decision-making loop. AI, machine learning (ML) models, large language models (LLM), and neural networks (NN) may be used interchangeably herein. For example, the solver may use ML models trained on historical and/or simulated NTN data (e.g., user equipment location, traffic demand, satellite availability, and/or environmental conditions). The solver may utilize the historical, simulated, and/or real-time data to predict coverage gaps and optimize the activation and configuration of satellite beams and/or network cells. For another example, the solver may run optimization algorithms. In some examples, the control logic of the solver may incorporate AI and/or ML models to improve decision-making related to resource allocation, coverage planning, and mobility management. At FIGS. 1A and 1B, controller 102 may model network 100, which may include coverage provided by the TN and NTN. In some examples, the NTN may be a SCS network.

As illustrated in FIGS. 1A and 1B, the TN may include base station 120a-120e. It should be recognized that the TN may include more or less base stations than base station 120a-120e. For example, the TN may include three base stations. For another example, the TN may include 20 base stations. Base station 120a-120e may perform similar functions and may be used interchangeably herein. In some examples, base station 120a may include radio equipment, antennas, power supplies, and/or backhaul connections. As illustrated in FIGS. 1A and 1B, the TN may further include network cell 110a-110e. In some examples, network cell 110a-110e may be geographical areas that may be provided with coverage from base station 120a-120e. For example, base station 120a may provide coverage to network cell 110a. For another example, base station 120b may provide coverage to network cell 110b. It should be recognized that network cell 110a-110e may perform similar functions may be used interchangeably herein. It should further be recognized that the TN may include more or less than network cell 110a-110e. For example, the TN may include 20 network cells. It should be recognized that base station 120a may provide coverage for more than just network cell 110a. For example, base station 120a may provide coverage for network cell 110a-110c. For another example, base station 120d may provide coverage for network cell 110b-110e.

As illustrated in FIGS. 1A and 1B, the NTN may include platform 124. In some examples, the NTN includes supplemental coverage from space (SCS). For example, platform 124 may include a LEO satellite. In other examples, the NTN may include one or more airborne components. For example, platform 124 may include an unmanned aerial vehicle (UAV). At FIGS. 1A and 1B, platform 124 may be used to provide coverage for network cell 110a. It should be recognized that the NTN may include more platforms than platform 124. For example, the NTN may include 16 platforms. At FIGS. 1A and 1B, controller 102 may detect a constellation of satellites in a telecommunications network that may include platform 124. In some examples, controller 102 may be utilized to coordinate the deployment of platform 124. As illustrated in FIGS. 1A and 1B, the TN may provide coverage for user equipment (UE) 112al and UE 112a2. At FIGS. 1A and 1B, UE 112a1 may be a UE at a first time, while UE 112a2 may be the same UE at a second time, which movement may be illustrated by an arrow between UE 112a1 and UE 112a2. In some examples, UE 112a1 and/or UE 112a2 may include consumer devices (e.g., smartphones, tablets, laptops, and/or wearables), fixed wireless devices (e.g., home routers and/or satellite terminals), Internet of Things (IoT) or Machine-to-Machine (M2M) devices (e.g., smart meters, connected vehicles, industrial sensors, and/or asset trackers), industrial equipment (e.g., ruggedized handhelds, private network terminals, and/or mission-critical communication devices), and/or specialized equipment (e.g., drones with cellular or satellite connectivity, augmented or virtual reality headsets, and/or medical devices with telemetry features). At FIGS. 1A and 1B, controller 102 may model a constellation of the NTN to construct a beam layout plan that may take into account dynamic changes in slant range and/or orbit precession. In some examples, the constellation may include antennas and signal propagation.

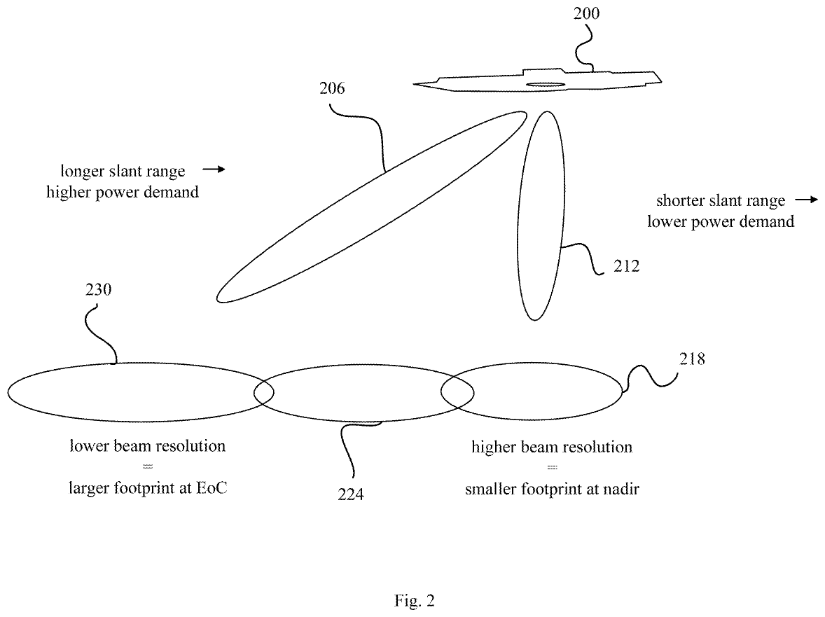

At FIGS. 1A and 1B, controller 102 may map coverage topology of the terrestrial cells (e.g., network cell 110a-110b as part of the TN) to enable dynamic provisioning of NTN resources in designated white spots according to a model plan. For example, controller 102 may deploy platform 124 to a designated white spot. At FIGS. 1A and 1B, after mapping the TN, controller 102 may determine a telecommunications network coverage provided by network cell 110a-110b (e.g., the terrestrial network). At FIGS. 1A and 1B, controller 102 may determine a beam layout plan to utilize platform 124 to provide network coverage to one or more areas (e.g., network cell 110a-110e). In some examples, the beam layout may include one or more areas that beams (e.g., beam 130) from satellites (e.g., platform 124) in a constellation may cover. In some examples, the beam layout plan may be based on a slant range (e.g., as illustrated in FIG. 2), orbit precession, beam shape, beam size, beam center, beam direction, or antenna patterns. At FIGS. 1A and 1B, controller 102 may control and/or configure the ground segment (e.g., the TN), a RAN for Long-Term Evolution (LTE) (e.g., 4G), 5G, and the space segment (e.g., NTN) in a coordinated time-space-aware fashion. In this way, the controller 102 may track how different coverage areas (e.g., satellite beams or network cells) may overlap or shift over time or geography. This may enable determination of where or when coverage may be available or missing. In some examples, controller 102 may utilize O-RAN control primitives and configuration primitives alongside non-O-RAN and/or non-3GPP mechanisms to enact on the end-to-end communications chain. At FIGS. 1A and 1B, controller 102 may model weather. In some examples, controller 102 may predict dynamic effects from weather or other conditions.

At FIG. 1A, white spot 106 may be a geographic area that may represent a coverage gap within or between network cell 110a-110e. In some examples, white spot 106 may be caused by geographic obstacles. For example, one or more mountains may block coverage from base station 120a-120e to white spot 106. In other examples, white spot 106 may be caused by infrastructure limitations. For example, outdated or insufficient base stations may not be able to provide coverage to white spot 106. At FIG. 1A, controller 102 may detect white spot 106. As illustrated in FIG. 1A, controller 102 may deploy platform 124 to provide coverage for white spot 106. In this way, the NTN may provide coverage for a geographic area that may not be covered by the TN. For example, platform 124 may make up for a gap in coverage due to a physical obstacle (e.g., mountain) that may prevent coverage for white spot 106 from base station 120a.

At FIG. 1B, in response to detecting white spot 106, controller 102 may create network cell 110f. In some examples, network cell 110f may be a new radio cell. In other examples, network cell 110f may be an LTE cell. As illustrated in FIG. 1B, after creating network cell 110f, controller 102 may utilize platform 124 to provide coverage for network cell 110f. In some examples, controller 102 may create a network cell upon a determination that network coverage is needed for a device entering white spot 106. For example, in response to detecting UE 112b moving toward white spot 106, controller 102 may create network cell 110f. In some examples, network cell 110f may be created with one or more initial parameters. For example, the one or more initial parameters may include an absolute radio frequency channel number (ARFCN), bandwidth, and/or synchronization signal block (SSB). It should be recognized that controller 102 may create more cells than network cell 110f. For example, controller 102 may create 10 cells. In some examples, network cell 110f may be created with a unique identifier and/or target configuration.

In an alternate example of FIG. 1B, network cell 110f may be cell that is not a part of the same network as controller 102. In that example, at FIG. 1B, controller 102 may detect network cell 110f. Controller 102 may be configured to retrieve network cell 110f parameters from a RAN and store the parameters in the data store of controller 102. It should be recognized that controller 102 may update network cell 110a-110e in the same fashion. For example, network cell 110b may be a part of a different network than controller 102. In that example, controller 102 may retrieve and/or store one or more parameters of network cell 110b.

At FIG. 1B, controller 102 may be configured to update or modify network cell 110f. At FIG. 1B, a network cell may be configured with one or more configuration parameters. For example, network cell 110f may be configured with an ARFCN, bandwidth, and/or SSB. At FIG. 1B, controller 102 may update the one or more network cell 110f configuration parameters. It should be recognized that controller 102 may be configured to remove any network cell from the network. For example, controller 102 may remove network cell 110f from the network. For another example, controller 102 may remove network cell 110a from the network.

At FIG. 1B, controller 102 may create zone 118. It should be recognized that zone 118 may be created before, simultaneously, or after deploying platform 124 to cover network cell 110f. For example, controller 102 may create zone 118 and network cell 110f simultaneously. For another example, controller 102 may create zone 118 after the one or more configuration parameters for network cell 110f have been set. In some examples, zone 118 may be a region between the edge of a network cell's coverage and a white spot. For example, zone 118 may be a region between white spot 106 and network cell 110a, network cell 110b, and network cell 110e. In some examples, controller 102 may create zone 118 to prevent interference between one or more signals provided from platform 124 to network cell 110f and one or more signals from base station 120a-120e as they provide coverage for network cell 110a-110e.

At FIG. 1B, controller 102 may dynamically provision an earth-fixed cell (EFC) in white spot 106 according to a model plan. In some examples, network cell 110f may be an EFC in network 100 (e.g., as part of the NTN). For example, network cell 110f may be an SCS EFC. At FIG. 1B, after determining that network cell 110f is part of the network. controller 102 may activate platform 124 for use in providing coverage for network cell 110f. At FIG. 1B, beam 130 may be activated on platform 124 to illuminate network cell 110f. Illumination of network cell 110f may refer to platform 124 providing network coverage for network cell 110f. At FIG. 1B, beam 130 may be configured and activated with an appropriate coverage, power, and frequency assignment to provide coverage to network cell 110f. In this way, beam 130 may be configured to provide coverage for the total area covered by network cell 110f, at a frequency that matches the configuration of network cell 110f, and enough power to provide a signal to serve network cell 110f. In some examples, controller 102 may assign platform 124 a coverage area that may include multiple network cells. For example, controller 102 may assign network cell 110a, network cell 110b, and network cell 110f to platform 124. In these examples, the multiple cells may be active, and each may be supported by one or more satellite beams. For example, platform 124 may utilize one or more beams 130 to provide coverage for the multiple network cells. In some examples, platform 124 may utilize beams 130 to provide coverage for the multiple network cells. For example, platform 124 may set a duty cycle for beams 130 to provide the multiple cells with network coverage. In this way, platform 124 may provide coverage and deliver a requested level of connectivity to the multiple cells in its coverage area by time-multiplexing beams 130 across the multiple cells. It should be recognized that controller 102 may utilize more than one platform to provide network coverage for network cell 110a-110f. In an example, platform 124 may become ineligible to continue illuminating network cell 110f. In this example, in response to a determination that platform 124 is ineligible to illuminate network cell 110f, platform 124 may deactivate beams 130. In some examples, the determination may be made by controller 102.

At FIG. 1B, controller 102 may determine that platform 124 is no longer eligible to illuminate network cell 110f. In some examples, the determination may be based on platform 124 being in a location that may no longer allow platform 124 to provide coverage for network cell 110f. In other examples, the determination may be based on platform 124 no longer having access to a required radio frequency spectrum. In other examples, the determination may be based on platform 124 being unable to illuminate network cell 110f for one or more technical failures. For example, platform 124 may have reached the end of its operational lifespan. At FIG. 1B, upon the determination that platform 124 is no longer eligible to illuminate network cell 110f, controller 102 may deactivate beams 130.

FIG. 2 illustrates an example platform 200 that may be utilized to provide network coverage to one or more network cells. In some examples, platform 200 may perform similar functions and/or have similar characteristics to platform 124 from FIGS. 1A and 1B. As illustrated in FIG. 2, platform 200 may activate beam 206 and/or beam 212 to provide network coverage to one or more network cells. At FIG. 2, beam 206 and/or beam 212 may include focused radio frequency signals that may be directed toward a specific geographical area on the Earth's surface to provide wireless network coverage. In some examples, beam 206 and/or beam 212 may be dynamically shaped, steered, and/or scheduled to align within the boundaries of a network cell (e.g., network cell 110a), enabling connectivity for user equipment (e.g., UE 112b) within that area. In some examples, one or more characteristics (e.g., power, frequency, and/or coverage footprint) of beam 206 and/or beam 212 may be managed by platform 200 and controlled by a network orchestration system (e.g., controller 100) to ensure optimal service delivery. As illustrated in FIG. 2, beam 206 and beam 212 may cause a footprint at the location to which they are directed. As illustrated in FIG. 2, beam 212 may be directed at a location that requires a shorter slant range (e.g., directly below platform 200). As a result of beam 212 being directed directly below platform 200 with a short slant angle, footprint 218 may have a higher beam resolution or may be a relatively small footprint at the nadir. As illustrated in FIG. 2, footprint 230 may be a result of beam 206. As illustrated in FIG. 2, as a result of beam 206 having a larger slant angle, footprint 230 may have a lower beam resolution or larger footprint at an edge of coverage for beam 206. At FIG. 2, footprint 224 may represent a result of a beam with a slant range in between those of beam 212 and beam 206. Footprint 224 may have a beam resolution and/or footprint size that are in between those of footprint 218 and footprint 230. In some examples, the slant range of beam 206 and/or beam 212 may determine a power demand for the beam to provide network coverage for the area to which they are directed. For example, beam 212 may have a shorter slant range, which may result in a lower power demand to provide network coverage, as illustrated in FIG. 2. For another example, beam 206 may have a larger slant range, which may result in a higher power demand to provide network coverage, as illustrated in FIG. 2.

Controller 102 may predict the effects of the placement of platform 124 (or platform 200) based on its relation to the network cell it may be servicing. Upon a determination that a beam (e.g., beam 130, beam 206, or beam 212) may have a shorter slant range, controller 102 may cause platform 124 or platform 200 to use a lower amount of power to illuminate the beam. In this way, controller 102 may preserve resources or prevent interference with signals from neighboring cells while providing coverage for one or more network cells. In other examples, upon a determination that a beam (e.g., beam 130, beam 206, or beam 212) may have a longer slant range, controller 102 may cause platform 124 or platform 200 to use a higher amount of power to illuminate the beam. In these examples, controller 102 may consider one or more conditions to make a determination of the power requirement to provide network coverage to one or more network cells.

In other examples, beam 130, beam 206, or beam 212 may have a higher beam resolution. The higher beam resolution may be due to a direction to which the beam is aimed or contacts the earth. In these examples, the higher resolution may result in a smaller footprint. Controller 102 may determine the footprint size based on the resolution or direction of the beam to determine an area of coverage that may be provided by the beam. In this way, controller 102 may determine one or more capabilities of one or more platforms to provide network coverage and coordinate resources (e.g., between the TN and NTN) given required coverage area.

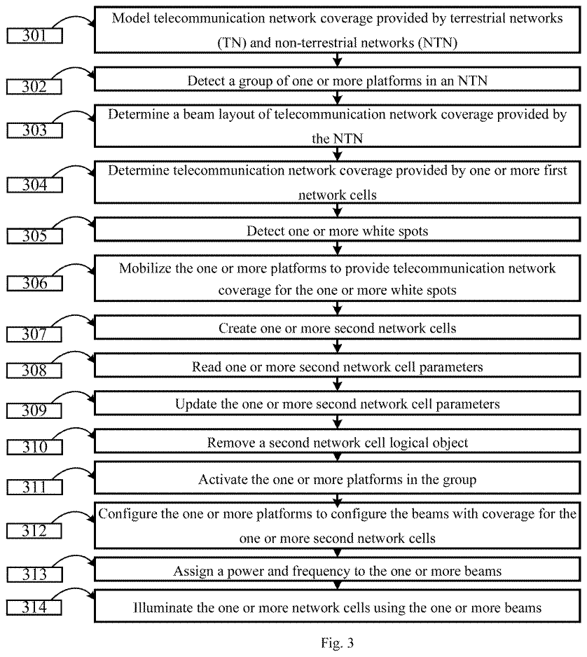

FIG. 3 illustrates an example flowchart illustrating an example method for managing coverage provided by a TN and NTN. At operation 301, a network controller (e.g., controller 102) may model telecommunication network coverage provided by TN and NTN. Modeling the network coverage may include operation 302, the network controller detecting a group of one or more platforms in an NTN. At operation 302, the group of one or more platforms may include at least one or more of one or more satellites, one or more high-altitude platform stations (HAPS), one or more unmanned aerial vehicles (UAV), and one or more manned aerial vehicles. Modeling the network coverage may further include operation 303, the network controller determining a beam layout of telecommunication network coverage provided by the NTN. In operation 303, the beam layout may include one or more areas that beams from one or more platforms in the group may cover based on slant range, orbit procession, beam shape, beam size, beam center, beam direction, and/or antenna patterns. Operation 304 may also be a part of modeling the network coverage. Operation 304 may include the network controller determining telecommunication network coverage provided by one or more first network cells. Operation 305 may also be included in modeling the network coverage. At operation 305, the network controller may detect one or more white spots. The one or more white spots may include one or more gaps in terrestrial cell coverage.

At operation 306, the network controller may mobilize the one or more platforms to provide telecommunication network coverage for the one or more white spots. Mobilizing the one or more platforms may include operations 307-314. At operation 307, the network controller may create one or more second network cells. The one or more second network cells may include one or more parameters that may include an absolute radio-frequency channel number, bandwidth, and synchronization signal block. The one or more second network cells may further include a geographic location identical to the geographic location of the one or more white spots. At operation 308, the network controller may read the one or more network cell parameters. At operation 309, the network controller may update the one or more second network cell parameters. At operation 310, the network controller may remove a second network cell logical object. The second cell logical object may include a cell identity, physical cell identity, frequency, bandwidth, neighboring cells, configuration, and/or performance metrics. At operation 311, the network controller may activate the one or more platforms in the group. At operation 312, the network controller may configure the one or more platforms to configure the beams with coverage for the one or more second network cells. At operation 313, the network controller may assign a power and/or frequency to the one or more beams. At operation 314, the network controller may illuminate the one or more second network cells using the one or more beams via the one or more platforms.

1. A method for managing coverage provided by a terrestrial network (TN) and a non-terrestrial network (NTN), the method comprising:
modeling telecommunication network coverage provided by terrestrial networks (TN) and non-terrestrial networks (NTN), wherein modeling the telecommunication network comprises;
detecting a group of one or more platforms in an NTN, wherein the group of one or more platforms comprises at least one of one or more satellites, one or more high-altitude platform stations (HAPS), one or more unmanned aerial vehicles (UAV), and manned aerial vehicles;
determining a beam layout of telecommunication network coverage provided by the NTN, wherein the beam layout comprises one or more areas that beams from one or more platforms in the group cover based on slant range, orbit precession, beam shape, beam size, beam center, beam direction, and antenna patterns;
determining telecommunication network coverage provided by one or more first network cells;
detecting one or more white spots, wherein the one or more white spots comprise one or more gaps in terrestrial cell coverage;
mobilizing the one or more platforms to provide telecommunication network coverage in the one or more white spots, wherein mobilizing the one or more platforms comprises:
creating one or more second network cells, wherein:
the one or more second network cells comprises one or more parameters;
the one or more parameters comprise an absolute radio-frequency channel number, bandwidth, and synchronization signal block; and
the one or more second network cells comprise a geographic location identical to a geographic location of the one or more white spots;
reading one or more second network cell parameters;
updating the one or more second network cell parameters;
removing a second network cell logical object, wherein the second network cell logical object comprises a cell identity, physical cell identity, frequency, bandwidth, neighboring cells, configuration, and performance metrics;
activating the one or more platforms in the group;
configuring the one or more platforms to configure the beams with coverage for the one or more second network cells;
assigning a power and frequency to the one or more beams; and
illuminating the one or more second network cells using the one or more beams.

2. The method of claim 1, wherein the NTN comprises a supplemental coverage from space (SCS) network, wherein the group of one or more platforms comprises a constellation of one or more satellites.

3. The method of claim 1, wherein the one or more second network cells comprise one or more new radio cells.

4. The method of claim 1, wherein the one or more second network cells comprise one or more long-term evolution (LTE) cells.

5. The method of claim 1, further comprising:
determining the one or more white spots are collocated with one or more earth-fixed cells; and
mobilizing the one or more earth-fixed cells to provide telecommunication network coverage to the one or more white spots.

6. The method of claim 5, wherein one or more earth-fixed cells are components of an SCS network.

7. The method of claim 1, further comprising:
determining that a platform is no longer eligible to illuminate a network; and
deactivating a beam from an ineligible platform.

8. The method of claim 1, further comprising, providing coverage, using the one or more platforms, to one or more second network cells in a coverage area by time-multiplexing one or more platform beams across the one or more network cells.
